(19) United States
(12) Patent Application Publication
(10) Pub. No.: US 2022/0007134 A1
(43) Pub. Date: Jan. 6, 2022

(54) SOUND MESSAGE SYSTEM, SERVER APPARATUS, INFORMATION PROCESSING METHOD OF SERVER APPARATUS, PROGRAM, AND DATA STRUCTURE OF SOUND MESSAGE

(71) Applicant: NEC Corporation, Minato-ku, Tokyo (JP)

(72) Inventor: Goh SHIBATA, Tokyo (JP)

(73) Assignee: NEC Corporation, Minato-ku, Tokyo (JP)

(21) Appl. No.: 17/279,290

(22) PCT Filed: Sep. 19, 2019
(86) PCT No.: PCT/JP2019/036724

§ 371 Date: Mar. 24, 2021

(30) Foreign Application Priority Data
Sep. 28, 2018 (JP) 2018-185716

(51) Int. Cl. H04W 4/02; G06F 3/16

(52) U.S. Cl. CPC H04W 4/023; G06F 3/165

(57) ABSTRACT

A server apparatus (100) includes: a location information acquisition unit (102) that acquires location information of a terminal held by a person or located around the person or location information of a person; a selection unit (104) that selects a jingle by using the acquired location information; a decision unit (106) that decides reproducible sound information by using the acquired location information; and a sound reproduction control unit (108) generates sound information so as to reproduce the jingle and the reproducible sound information in this order, and causes the terminal to reproduce the generated sound information.

### TECHNICAL FIELD

The present invention relates to a sound message system, a server apparatus, an information processing method of a server apparatus, a program, and a data structure of a sound message. In particular, the present invention relates to a sound message system, a server apparatus, an information processing method of a server apparatus, a program, and a data structure of a sound message for sound guidance in a pre-motivation state.

### BACKGROUND ART

Recently, personal terminals such as personal computers, smartphones, and tablets have become widespread. The information distributor delivers information such as advertisements to this personal terminal.

Patent Document 1 discloses a technique for outputting the contents of an advertisement through sound.

### RELATED DOCUMENT

### Patent Document

[Patent Document 1] Japanese Patent Application Publication No. 2018-28533

### SUMMARY OF THE INVENTION

### Technical Problem

As described above, sound information may be delivered to the terminal. However, even if the holder of the terminal recognizes the information, the holder may not show motivation for the information.

The present invention has been made in view of the above circumstances, and an object of the present invention is to induce the holder of the terminal to have motivation for the sound information in a case where the sound information is delivered to the terminal.

### Solution to Problem

In each aspect of the present invention, the following configurations are adopted in order to solve the above-mentioned problems.

A first aspect relates to a sound message system.

The sound message system according to the first aspect includes

a server apparatus, and

a terminal.

The server apparatus includes

a location information acquisition unit that acquires location information of a terminal or location information of a person,

a selection unit that selects a jingle by using the acquired location information,

a decision unit that decides reproducible sound information by using the acquired location information, and

a transmission unit that generates sound information so as to reproduce the jingle and the reproducible sound information in this order, and transmitting the generated sound information to the terminal.

The terminal includes

a unit that transmits the location information to the server apparatus,

a unit that receives the sound information from the server apparatus, and

an output unit that outputs the sound information when the sound information is received.

A second aspect relates to a server apparatus.

The server apparatus according to the second aspect includes

a location information acquisition unit that acquires location information of a terminal or location information of a person,

a selection unit that selects a jingle by using the acquired location information,

a decision unit that decides reproducible sound information by using the acquired location information, and

a sound reproduction control unit that generates sound information so as to reproduce the jingle and the reproducible sound information in this order, and causes the terminal to reproduce the generated sound information.

A third aspect relates to an information processing method executed by at least one computer.

The information processing method according to the third aspect causes

a server apparatus to execute

acquiring location information of a terminal or location information of a person,

selecting a jingle by using the acquired location information,

deciding reproducible sound information by using the acquired location information, and

generating sound information so as to reproduce the jingle and the reproducible sound information in this order, and causing the terminal to reproduce the generated sound information.

A fourth aspect relates to a data structure of a sound message.

The data structure of the sound message according to the fourth aspect is

a data structure of a sound message that is generated to be reproduced on a terminal.

The sound message includes

a jingle selected by using location information of the terminal or location information of a person, and

reproducible sound information decided by using the location information in this order, which are reproduced in this order.

The reproducible sound information further includes

information about the content that a person is able to experience in relation to the location information, and

information for determining the facility indicated by the location information in this order, which are reproduced in this order.

Another aspect of the present invention may relate to a program that causes at least one computer to execute the method of the third aspect, or a storage medium that can be read by a computer that stores such a program. This storage medium includes a non-temporary medium.

This computer program includes computer program code that causes the computer to execute the information processing method on a server apparatus in a case where the program is executed by the computer.

Any combination of the above components and modifications of the expression of the present invention of the method, the apparatus, the system, the storage medium, the computer program, and the like are also available as aspects of the present invention.

Further, the various components of the present invention do not necessarily have to be independent of each other. A plurality of components may be formed as one member. One component may be formed of a plurality of members. A certain component may be a part of another component. A part of a certain component may overlap with a part of another component.

Further, although the method and the computer program of the present invention describe a plurality of steps in order, the order of description does not limit the order in which the plurality of steps are executed. Therefore, in a case of implementing the method and computer program of the present invention, the order of the plurality of steps can be changed within a range that does not cause trouble in the contents.

Furthermore, the method of the present invention and the plurality of steps of the computer program are not limited to a method and steps executed at different timings. Therefore, another step may occur during the execution of a certain step, or the execution timing of the certain step and the execution timing of the other step may partially or completely overlap.

### Advantageous Effects of Invention

According to each of the above aspects, there are provided the sound message system, the server apparatus, the information processing method of the server apparatus, the program, and the data structure of the sound message that induce the holder of the terminal to have motivation for the sound information, in a case where sound information is delivered to the terminal.

### BRIEF DESCRIPTION OF THE DRAWINGS

The above-mentioned object and other objects, features, and advantages are further clarified by the preferred embodiments described below and the accompanying drawings.

FIG. 1 is a diagram conceptually showing a configuration of a sound message system according to an embodiment of the present invention.

FIG. 2 is a diagram showing an example of a data structure of a location information storage unit.

FIG. 3 is a diagram showing a data structure of sound data.

FIG. 4 is a functional block diagram showing a logical configuration of a server apparatus.

FIG. 5 is a diagram showing an example of a data structure of a jingle storage unit.

FIG. 6 is a functional block diagram that logically shows a configuration of a terminal.

FIG. 7 is a block diagram showing an example of a configuration of a computer that realizes the server apparatus or the terminal.

FIG. 8 is a flowchart showing an example of operations of the server apparatus.

FIG. 9 is a flowchart showing an example of terminal operations.

FIG. 10 is a functional block diagram that logically shows a configuration of the server apparatus.

FIG. 11 is a diagram showing an example of data structures of an action history storage unit and a reproducible sound information storage unit.

FIG. 12 is a diagram showing another example of the data structure of the action history storage unit.

FIG. 13 is a functional block diagram showing a logical configuration of Example 1.

### DESCRIPTION OF EMBODIMENTS

Hereinafter, embodiments of the present invention will be described with reference to the drawings. In all drawings, similar components are designated by the same reference numerals, and description thereof will not be repeated as appropriate.

### First Embodiment

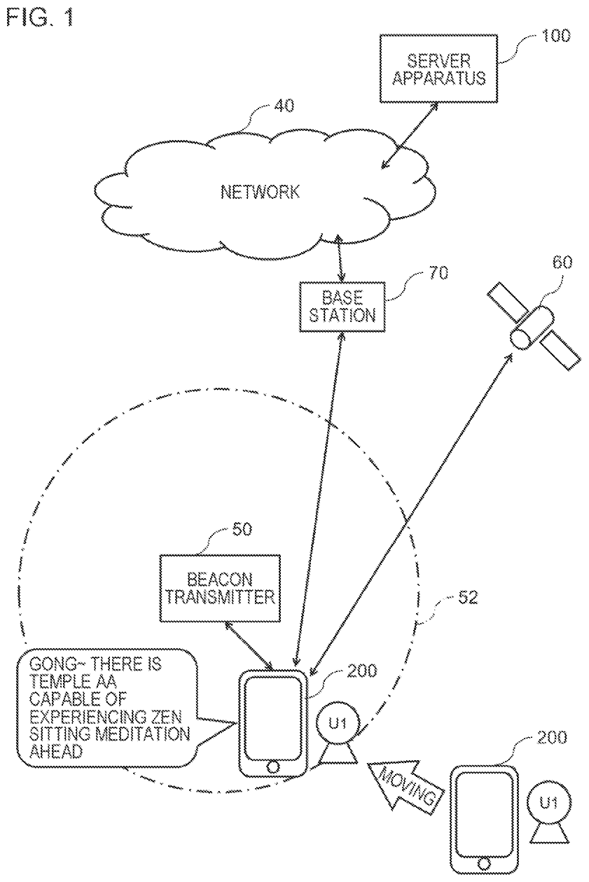

FIG. 1 is a diagram conceptually showing a configuration of a sound message system 1 according to an embodiment of the present invention.

The sound message system 1 includes a server apparatus 100 and a terminal 200. For example, the server apparatus 100 causes the terminal 200 that has entered the communication area 52 of the beacon transmitter 50 to reproduce and output a sound message according to the situation. The beacon transmitter 50 may, for example, transmit a beacon through communication conforming to the Bluetooth (registered trademark) standard, or may be included in an access point (not shown) for wireless LAN (Local Area Network) communication, so-called Wi-Fi (Wireless Fidelity) communication and transmit a beacon.

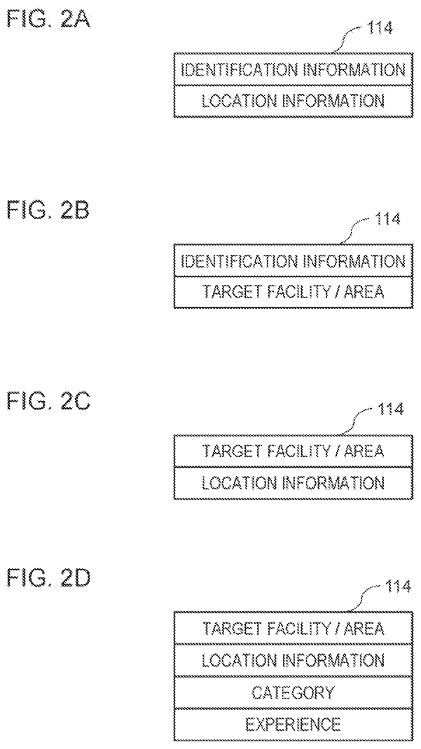

The beacon includes the location information, and the terminal 200 may acquire the location information from the beacon and transmit the information to the server apparatus 100. Alternatively, the beacon may be configured to include identification information such as an internet protocol (IP) address instead of location information. As shown in FIG. 2A, the server apparatus 100 stores the identification information and the location information in the location information storage unit 114 in association with each other. The terminal 200 may transmit the identification information acquired from the beacon to the server apparatus 100, and the server apparatus 100 may determine the location information from the identification information. In other words, the beacon transmitter 50 transmits a beacon including information that can be used to determine the location information around the beacon transmitter 50.

Further, as shown in FIG. 2B, the location information storage unit 114 may store the identification information in association with the information indicating a facility or an area.

In the present specification, the term “acquisition” includes at least one of the following meanings. The own apparatus acquires data or information stored in another apparatus or storage medium (active acquisition). For example, data or information is received through a request or inquiry to another apparatus, data or information on another apparatus or a storage medium is accessed and read, and so on. In addition, data or information output is input to the own apparatus from another apparatus (passive acquisition). For example, delivered (or transmitted, push-notified, or the like) data or information is received, and so on. The term also includes selecting and acquiring the received data or information, or selecting and receiving the delivered data or information.

In addition, the beacon does not have to include either location information or identification information. The terminal 200 may acquire the location information by using the global positioning system (GPS) reception function of the terminal 200 in a case of receiving a beacon as a trigger, and transmit the location information of the terminal 200 to the server apparatus 100. Alternatively, in a case of receiving a beacon as a trigger, the terminal 200 notifies the server apparatus 100 of the reception of the beacon. Then, the server apparatus 100 receives the notification, and may specify, for example, the location information of the terminal 200, based on the information of the location registration of the terminal 200 in the cellular telephone network (not shown).

The terminal 200 is a terminal held by a person (user U1) or located around the person. The terminal 200 may be the property of a person or may be lent to a person.

The terminal 200 includes, for example, a smartphone, a tablet terminal, a notebook personal computer, a mobile phone, a personal handy-phone system (PHS), a personal digital assistants (PDA), a wearable terminal, a portable digital music player, a portable video player, a portable game machine, a portable television receiver, and the like. The terminal 200 is not particularly limited as long as it is a portable or wearable terminal having a function of outputting sound. Further, the terminal 200 may be an earphone device specialized for outputting a sound message, a so-called guide terminal, or a sound output terminal dedicated to this system. Further, the terminal 200 may be an item of a transportation apparatus used by the user U1 (for example, a vehicle, an automobile, a two-wheeled automobile, a bicycle, a train, a bus, a rear car, a rickshaw, a vessel (ship and other watercraft), an airplane, a rocket, and an artificial satellite, a drone, a balloon, and the like).

Further, a plurality of terminals, for example, a wearable terminal and a smartphone may cooperate to share and execute each function of the terminal 200, thereby realizing the entire function of the terminal 200. For example, the wearable terminal may detect the location information of the user U1, motion of the user U1 (moving velocity, stride, moving direction, face or body orientation, and the like), a state of the user U1 (heart rate, energy consumption, body temperature, and the like), climate information of the surroundings (temperature, atmospheric pressure, and the like), and the like. Then, the wearable terminal may transmit the detected information to the smartphone, and the smartphone may transmit the acquired information to the server apparatus 100. Further, in another example, the wearable terminal may output the sound message, and the smartphone may perform the other processing.

An object of the present invention is to motivate a person by means of a sound message. For that purpose, it is necessary to inspire a person to select a specific action (verb) immediately after the motivation. However, in the present invention, in order to achieve motivation only by delivering a sound message, it is important that the delivered message includes specific information for recalling the “experience” about the target rather than information for explaining the target.

The contents of the message do not include information for explaining the target, but specific information for recalling the “experience” about the target. It is more preferable that the message content is concise. In the present invention for the purpose of giving motivation or inducing action, the design of the message lies in the viewpoint of the receiver, not in the viewpoint of the message distributor who is the advertiser. This differs from approach in the “consumer's perspective” that has been said in conventional marketing in terms of the following points.

(a1) The contents of the message is not the consumer's perspective but the “format” of the message is the consumer's perspective.

(a2) The message does “not” include content allowing comparison with others.

Specific examples of the above two points are shown below.

First, in order to motivate the user or induce the user to take an action, it is not the primary purpose to convey the explanatory information of the target. Therefore, the message is considered to be information, which is presented to prompt a person to take a specific action, so-called “fishhook”.

For example, the message “AA temple is the oldest temple in Japan built by CC during the BB era”, which provides information about tourist spots and facilities in tourism services, is information for making the recipient think of what to do there after hearing the message. From a cognitive and psychological point of view, this kind of information is far from motivation or action induction. For messages related to motivation or action induction, it is preferable for the recipient to have a direct and intuitive understanding of his or her own action choices (what to do there).

The message of the present invention is a message that recalls “experience” owing to a format that describes what is possible there, such as “You can experience Zen meditation ahead” or “You can see a drawing of beautiful woman drawn by BBB”. This is the meaning of (a1) mentioned above.

Further, if possible, the message of the present invention should be a message emphasizing the purport that the recalled “experience” is possible “only there”. This is the meaning of (a2) mentioned above.

Many experiences and impressions of visiting the facility in the past are published on the Internet on social networking service (SNS) such as blogs and Twitter (registered trademark). Therefore, in the sound message system 1, for example, these public information can be accumulated and processed to create a message text that recalls the experience.

The message generation may be created by a person, may be automatically generated by an apparatus using artificial intelligence (AI) technology, or may be a combination thereof. The generated message is stored in the reproducible sound information storage unit 112 in association with the facility, which will be described later.

In addition, in a case where a person have similar experiences, it is possible to further motivate the person or induce the person to take actions by delivering experience message texts that do not overlap. Whether or not a person has had the similar experience can be decided by referring to a person's action history. This action history will be described in detail in the example embodiment described later.

For persons, messages are reproduced in the form of interrupting person actions and conversations. Therefore, the sudden sounding may cause confusion and may make the person feel uncomfortable. In the present invention, the use of jingles is adopted as a means for solving such a problem. The jingles are used as a method of alerting that is commonly used in auditory-only media such as radio, and use specific patterns of sound elements to clarify context transitions such as commercials and programs.

In the present invention, a jingle is a short melody (including melody, music, and a song) and a short sound (natural sound, synthetic sound, musical instrument sound, voice, synthetic voice) having an effect of noticing and evoking a predetermined image or a combination thereof. The term “short” is defined as a length at which the output time of the jingle is at least about 1 to 3 seconds, and a length at which the user U1 can recognize the jingle at least.

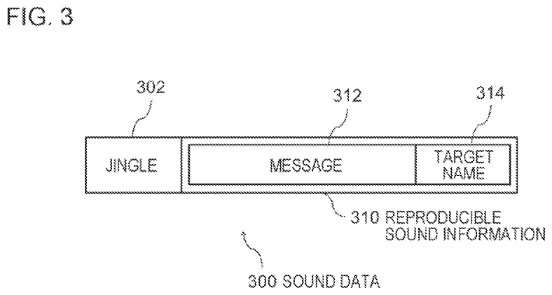

FIG. 3 is a diagram showing a data structure of the sound data 300 of the present example embodiment.

The sound data 300 is configured such that the jingle 302 and the reproducible sound information 310 are reproduced in this order. Further, the reproducible sound information 310 is configured such that a message 312 and a target name 314 are reproduced in this order.

In such a manner, by first playing the jingle at the beginning of the message, the reproduction of the message is preannounced to increase a degree of acceptance of the person therefor. In other words, the jingle function is “a sound element that is able to naturally interrupt the person”.

The person easily recognizes that buzzers and alert sounds that use sine waveforms generally have few overtone components, but tend to be sounds that are direct to the brain. Therefore, the buzzers and alert sounds are useful in terms of calling attention and danger, but are mostly not comfortable sounds. In addition, since sound devices such as earphones are premised on listening at a close distance to the ear, it is likely to feel stress in a case where a sharp sound is used for the attack part of the sound (beginning of sound). Therefore, in the present invention, the jingle provides a sound with a rich overtone structure and an easily acceptable auditory experience by combining a plurality of tones with a time lag.

For example, it is possible to improve the material understanding by using natural sounds that remind us of places such as the murmuring of a river in the case of a river and the sound of a waterfall in the case of a waterfall. However, in the case of natural sounds, there is a drawback that it is difficult to recognize the sounds unless the listening time is increased.

Next, in a case where a realistic instrument sound of a piano, a violin, or the like is used even in the same raw sounds, the shape of the instrument and the image of each instrument that the listener has experienced will become clearer. As a result, there is a risk that the impression of the jingle will excessively increase.

On the other hand, in the case of electronic sound, it is difficult to imagine a concrete image, but it is possible to give a certain impression to everyone. Also, in the case of a realistic musical instrument sound, there is no sense of incongruity even in a case where a tone sequence that is difficult to play or has a remarkably peculiar playing style due to the characteristics of the musical instrument is used. Therefore, the degree of freedom in pitch and chords increases, and it is easy to set the functionality as sound. As a result, it is important to have a sense of balance in which the sound is an electronic sound and is realistic enough not to be a buzzer (a sound that is commonly heard).

The jingle designed in such a manner is stored in the jingle storage unit 110, which will be described later, in association with the facility, the experience content, and the like.

As shown in FIG. 3, the reproducible sound information 310 includes a message 312 indicating information related to the contents that a person is able to experience in relation to the location information, and a target name 314 indicating information for determining a facility indicated by the location information, in this order.

The information about the experience content included in message 312 is, for example, “Let's change into Maiko's costume and walk around the town of Kyoto as Maiko. You can also take a commemorative photo with a real Maiko.” The target name 314 subsequent to this message 312 is, for example, “XYZ photo studio” or the like.

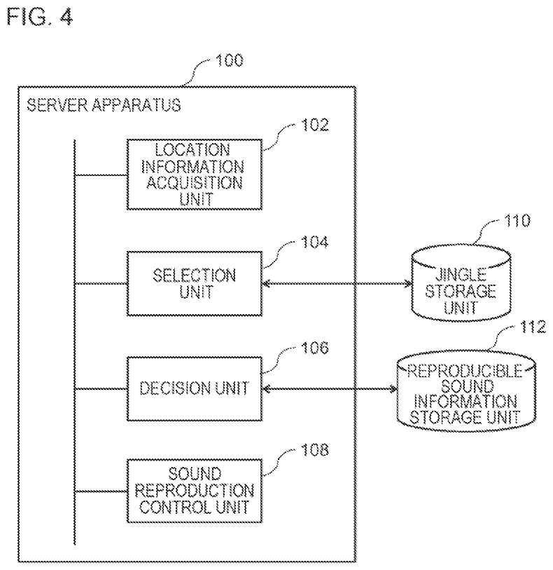

FIG. 4 is a functional block diagram showing a logical configuration of a server apparatus 100 of the present example embodiment.

The server apparatus 100 includes a location information acquisition unit 102, a selection unit 104, a decision unit 106, and a sound reproduction control unit 108.

The location information acquisition unit 102 acquires location information of the terminal 200 or location information of a person (user U1). The selection unit 104 selects a jingle using the acquired location information. The decision unit 106 decides the reproducible sound information using the acquired location information. The sound reproduction control unit 108 generates sound information so as to reproduce the jingle and the reproducible sound information in this order, and reproduces the generated sound information on the terminal 200.

The method of acquiring the location information of the terminal 200 is exemplified below, but is not limited thereto.

(b1) Receive the information from the terminal 200.

(b2) Acquire the information, which is acquired by the location registration of the terminal 200, from the base station 70.

(b3) Acquire the information from the access point accessed by the terminal 200.

The server apparatus 100 is connected to the jingle storage unit 110 and the reproducible sound information storage unit 112. The jingle storage unit 110 and the reproducible sound information storage unit 112 may be an internal storage apparatus of the server apparatus 100, an external storage apparatus, or a combination thereof.

The timing of acquiring the location information is a timing when the location information transmitted from the terminal 200, the identification information for identifying the location information, or the notification that the beacon has been received is received, or a timing periodic at regular intervals. Further, the server apparatus 100 may actively acquire the information, or may passively acquire the information transmitted from the outside.

In a case where the terminal 200 that has received the beacon transmitted from the beacon transmitter 50 receives the location information transmitted, it is the timing to transmit the reproducible sound information (hereinafter, also referred to as “sound message”) to the terminal 200. Therefore, the server apparatus 100 may transmit a sound message to the terminal 200 at the timing of receiving the message.

On the other hand, in a case where the location information of the terminal 200 is periodically received, the location information acquisition unit 102 of the server apparatus 100 further performs a process of deciding whether or not the condition for delivering the sound message is satisfied based on the location information.

As shown in FIG. 2C, the server apparatus 100 stores the target facility or target area for delivering the sound message in the location information storage unit 114 in association with the location information. The location information acquisition unit 102 is able to decide whether or not the acquired location information corresponds to the target facility or the target area with reference to the location information storage unit 114. In a case where it is decided that the location is a target facility or a target area, a process of delivering a sound message is performed based on the location information.

A plurality of jingles are stored in the jingle storage unit 110.

The selection unit 104 determines the attribute of the location of the location information acquired by the location information acquisition unit 102, and selects further the jingle based on the determined attribute.

The selection unit 104 determines the facility using the location information, and sets the category of the facility as the attribute of the location. The selection unit 104 may use the attribute of the content that can be experienced at the location indicated by the location information as the attribute of the location. The selection unit 104 may combine the category of the facility and the attribute of the content that can be experienced at the location indicated by the location information, as the attribute of the location.

For example, as shown in FIG. 2D, the location information storage unit 114 stores at least one of the category and the experience contents in association with the information, which indicates the target facility or the target area, and the location information.

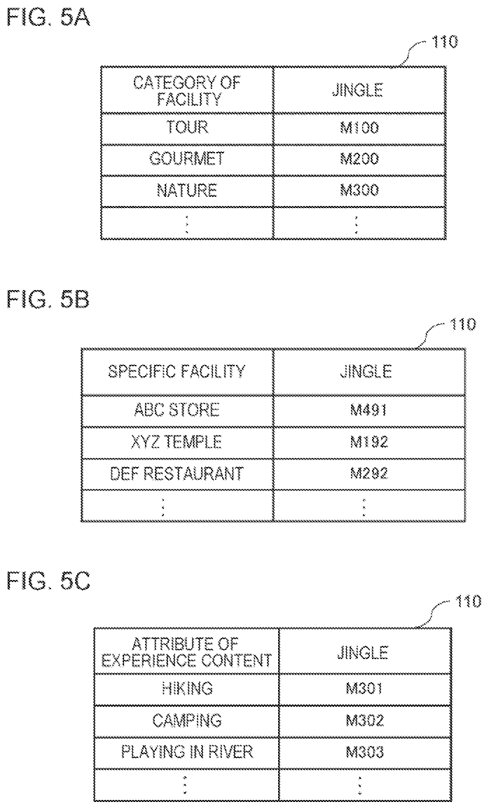

For example, facility categories include tourism, gourmet, nature, culture, leisure, commerce, events, education, politics, transportation, and the like. For example, as shown in FIG. 5A, jingles may be associated with the respective facility categories and stored in the jingle storage unit 110. Further, as shown in FIG. 5B, the jingle peculiar to the facility may be associated with each facility and stored in the jingle storage unit 110.

A case where a jingle is selected using both the tables of FIGS. 5A and 5B will be described. The selection unit 104 determines the facility from the location information with reference to the location information storage unit 114 of FIG. 2, and then first refers to the table of FIG. 5B. If there is a jingle which is peculiar to a facility and associated with the facility, the selection unit 104 selects the jingle. If there is no jingle which is peculiar to the facility and associated with the facility, then the location information storage unit 114 of FIG. 2D is referred to determine the facility category. Then, the jingle associated with the determined category is selected with reference to the table of FIG. 5A.

In the example of FIG. 5C, the jingle is associated with the attribute of the content that can be experienced and stored in the jingle storage unit 110. It is preferable that the jingle storage unit 110 includes at least one of FIGS. 5A, 5B, and 5C. Further, the jingle storage unit 110 may be configured to associate the jingle with the location information or the information indicating the facility or area.

A plurality of reproducible sound information pieces are stored in the reproducible sound information storage unit 112, and are stored in at least one file format of sound data and text data.

The reproducible sound information storage unit 112 stores a table in which the file names and path information of the reproducible sound information are associated with location information or information indicating a facility or area, and a data file of the reproducible sound information.

In the examples of FIGS. 5A to 5C, one jingle is associated with the attribute of one location. However, a plurality of jingles may be associated with one type of attribute of a location. In this case, the selection unit 104 may select a different jingle each time when the location information of the same terminal 200 or the same user U1 is acquired a plurality of times during a predetermined period, based on the action history described later.

In a case where the file format is text data, the server apparatus 100 or the terminal 200 includes a text reading unit, and the text reading unit is able to generate and output sound data. In a case where the terminal 200 has a text reading unit, the sound reproduction control unit 108 may transmit the reproducible sound information of the text data to the terminal 200. The text reading unit can be realized, for example, in an application having a text reading function.

The format of the sound data file is not particularly limited, and various formats such as WAV, AIFF, mp3, ACC, WMA, ATRAC, and mp4 can be considered, but the format is made to be reproducible by the terminal 200 that performs reproduction output.

For example, it is preferable that the terminal 200 has a function that allows the user to select and set a reproducible file format. For example, the setting may be accepted through the setting menu of the application or the like, or the user registered in advance may log in to the sound message system 1 from the terminal 200, and the setting on the setting screen or the like may be accepted. The setting information can be included in the user information and registered for each user.

The server apparatus 100 is able to acquire the setting information and transmit the sound data to the terminal 200 in the set file format. Further, if the earphone device is dedicated to the sound message system 1 of the present invention, the sound data can be set in advance in a predetermined file format.

Further, the terminal 200 may read at least one of the jingle from the jingle storage unit 110 and the reproducible sound information from the reproducible sound information storage unit 112 and reproduce the sound. In that case, the sound reproduction control unit 108 of the server apparatus 100 only has to transmit to the terminal 200 information that can be used to determine at least one of the jingle and the reproducible sound information to be output as sound.

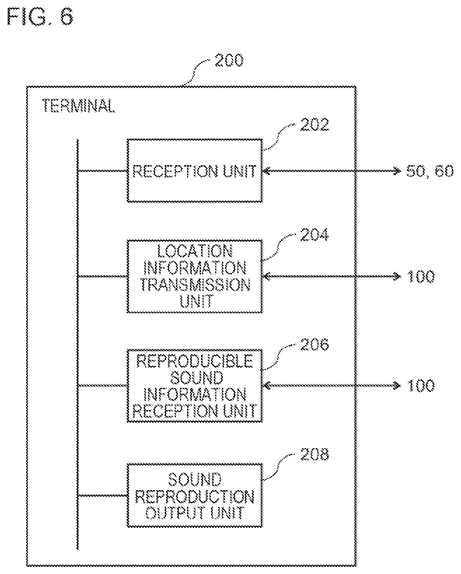

FIG. 6 is a functional block diagram that logically shows the configuration of the terminal 200 of the present example embodiment.

The terminal 200 includes a location information acquisition unit 202, a location information transmission unit 204, a reproducible sound information reception unit 206, and a sound reproduction output unit 208.

The location information acquisition unit 202 acquires the location information of the terminal 200 or the vicinity of the terminal 200.

The method by which the terminal 200 acquires the location information is exemplified below, but is not limited thereto.

(c1) The location information is received from the global positioning system (GPS) satellite 60 or the quasi-zenith satellite.

(c2) The location information is acquired from the beacon signal received from the beacon transmitter 50.

For example, the above (c1) is suitable for acquiring location information for an outdoor location or a wide area. The above (c2) is suitable for acquiring location information for an indoor location or a relatively narrow range.

The terminal 200 may switch between the above-mentioned location information acquisition methods of (c1) and (c2) by detecting, for example, whether the location is indoor or outdoor through a geomagnetic sensor.

The location information transmission unit 204 transmits the acquired location information to the server apparatus 100.

Further, as described above, the location information acquisition unit 202 may receive the beacon transmitted from the beacon transmitter 50, and the location information transmission unit 204 may transmit information notifying that the beacon has been received to the server apparatus 100. In the configuration, the location information of the terminal 200 is determined on the server apparatus 100 side.

The reproducible sound information reception unit 206 receives the reproducible sound information from the server apparatus 100.

The sound reproduction output unit 208 creates the reproducible sound information received by the reproducible sound information reception unit 206 and outputs the information from a speaker (not shown).

It is preferable that the timing at which the sound reproduction output unit 208 outputs the reproducible sound information is timing when the reproducible sound information is received. Further, the reproducible sound information may be streamed from the server apparatus 100, and the terminal 200 may reproduce the reproducible sound information by the sound reproduction output unit 208 while receiving the reproducible sound information through the reproducible sound information reception unit 206.

In another configuration, a plurality of reproducible sound information pieces of the terminal 200 may be stored in advance, information of the jingle 302 and the reproducible sound information 310 to be output from the server apparatus 100 may be received. Then, the sound data 300 may be constructed in accordance with the received information and may be reproduced and output.

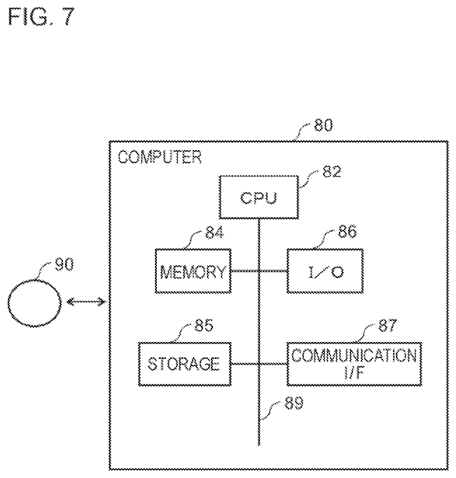

FIG. 7 is a block diagram showing an example of the configuration of a computer 80 that realizes the server apparatus 100 of FIG. 4 or the terminal 200 of FIG. 6.

The computer 80 of the present example embodiment includes a central processing unit (CPU) 82, a memory 84, a program 90 which is loaded in the memory 84 and which realizes the components of the functional block diagram in FIG. 4 or FIG. 6, which will be described later, a storage 85 that stores the program 90, an input output (I/O) 86, and a communication interface (communication I/F 87).

The CPU 82, the memory 84, the storage 85, the I/O 86, and the communication I/F 87 are connected to each other through the bus 89, and the CPU 82 controls the server apparatus 100 or the terminal 200. However, the method of connecting the CPU 82 and the like to each other is not limited to the bus connection.

The memory 84 is a memory such as a random access memory (RAM) or a read only memory (ROM). The storage 85 is a storage apparatus such as a hard disk, a solid state drive (SSD), or a memory card. Further, the storage 85 may be a memory such as a RAM or a ROM.

Each function of the server apparatus 100 or the terminal 200 can be realized by the CPU 82 reading the program 90, which is stored in the storage 85, into the memory 84 and executing the program 90.

The I/O 86 controls input and output of data and control signals between the computer 80 and another input output apparatus. The another input output apparatus includes, for example: an input apparatus (not shown) such as a keyboard, touch panel, mouse, operation switch, operation button, and microphone connected to the computer 80; an output apparatus (not shown) such as a display, a printer, and a speaker; and an interface between the input output apparatuses and the computer 80. Further, the I/O 86 may perform control of input and output of data to and from a reading or writing apparatus (not shown) of another storage medium.

The communication I/F 87 includes various communication interfaces for communicating between the computer 80 and an external apparatus. The communication function of the server apparatus 100 or the terminal 200 is exemplified below, but is not limited thereto.

(d1) Short-range wireless communication function

The short-range wireless communication includes, for example, Bluetooth communication, infrared communication, wireless communication using a radio frequency identification (RFID) system, wireless communication according to a near field communication (NFC) standard, and the like. The terminal 200 is able to receive the beacon transmitted from the beacon transmitter 50 by the short-range wireless communication function.

(d2) Wireless local area network (LAN) (hereinafter referred to as Wi-Fi) communication function

The server apparatus 100 connects to a network 40 such as the Internet through an access point such as a router by using a Wi-Fi communication function.

The terminal 200 is able to receive the beacon from the access point by using the Wi-Fi communication function. Further, the terminal 200 connects to a network 40 such as the Internet through an access point by using the Wi-Fi communication function.

(d3) Mobile data communication function (for example, 3rd generation (3G), 4th generation (4G), long term evolution (LTE), and the like)

The terminal 200 may communicate with the server apparatus 100 by connecting to a cellular telephone network (not shown) through the base station 70 through the mobile data communication function.

The server apparatus 100 and the terminal 200 is able to communicate through the network 40 or another network.

(d4) GPS reception function

The terminal 200 receives location information from the GPS satellite 60 using the GPS reception function.

Each component of the server apparatus 100 of FIG. 4 or the terminal 200 of FIG. 6 is realized by any combination of hardware and software of the computer 80 of FIG. 7. And, it is understood by those skilled in the art that there are various modifications of the realization method and the apparatus. The functional block diagram showing the server apparatus 100 or the terminal 200 of each example embodiment described below shows not a configuration of a hardware unit but a block of a logical functional unit.

In each figure, the configuration of the portion not related to the essence of the present invention is omitted and is not shown.

The CPU 82 of the computer 80 of FIG. 7 reads the program 90 stored in the storage 85 into the memory 84 and executes the program, thereby realizing the functions of each unit of FIG. 4 of the server apparatus 100 or each unit of FIG. 6 of the terminal 200.

The computer program of the present example embodiment may be stored on a computer-readable storage medium. The storage medium is not particularly limited, and various forms can be considered. In addition, the program may be loaded from the storage medium into the memory of the computer, or may be downloaded to the computer through the network and loaded into the memory.

The storage medium that stores the computer program 90 includes a medium that can be used by the non-transitory tangible computer 80, and the program code that can be read by the computer 80 is embedded in the medium. In a case where the computer program 90 is executed on the computer 80, the computer 80 is made to execute the following information processing method for realizing the server apparatus 100 or the terminal 200.

In a case where the terminal 200 is, for example, a device such as a guide terminal that is lent to the user U1 on the spot, a program that realizes each function of each unit of FIG. 6 may be installed in the terminal 200 in advance. In a case where the terminal 200 is, for example, a smartphone owned by a user, the terminal 200 of the present invention may be realized by installing and executing an application program that realizes each function of each unit shown in FIG. 6.

The computer program of the present example embodiment is described to cause a computer for realizing the server apparatus 100 to execute steps of: acquiring the location information of the terminal 200 or the location information of a person; selecting a jingle by using the acquired location information; deciding reproducible sound information by using the acquired location information; and generating sound information so as to reproduce the jingle and the reproducible sound information in this order, and reproducing the generated sound information (sound data 300) on the terminal 200.

The operation of the server apparatus 100 configured in such a manner will be described below.

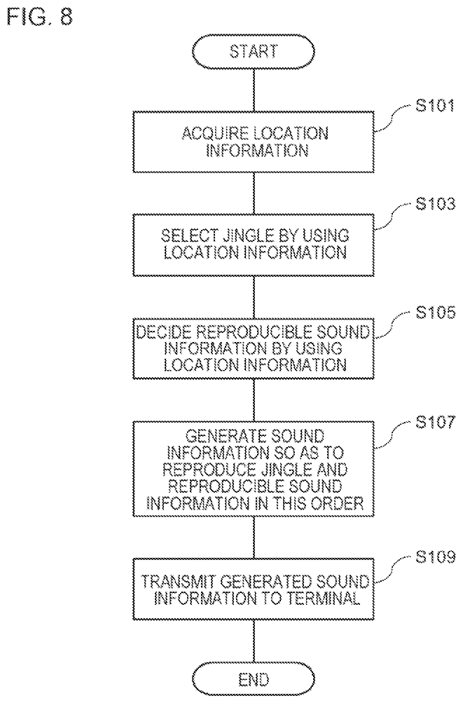

FIG. 8 is a flowchart showing an example of the operation of the server apparatus 100.

First, in the server apparatus 100, the location information acquisition unit 102 acquires the location information of the terminal 200 (step S101). Then, the selection unit 104 selects the jingle using the acquired location information (step S103). Then, the decision unit 106 decides the reproducible sound information by using the acquired location information (step S105). Then, the sound reproduction control unit 108 generates sound information so as to reproduce the jingle and the reproducible sound information in this order (step S107), and reproduces the generated sound information on the terminal 200 (step S109).

Next, the operation of the terminal 200 will be described.

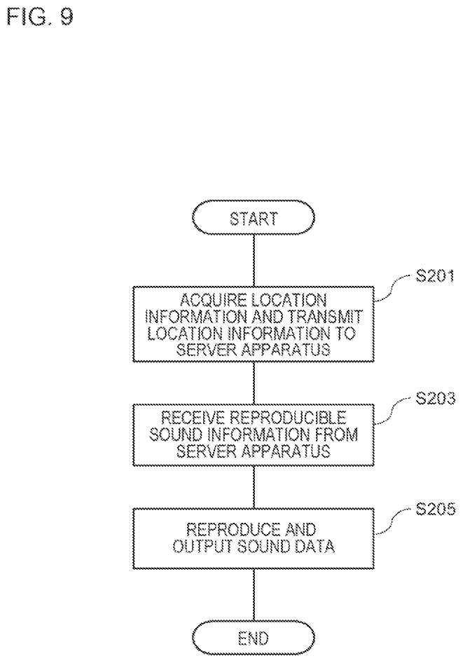

FIG. 9 is a flowchart showing an example of the operation of the terminal 200.

First, in the terminal 200, the location information acquisition unit 202 acquires the location information (step S201), and the location information transmission unit 204 transmits the acquired location information to the server apparatus 100 (step S203). Then, the reproducible sound information reception unit 206 reproduces the reproducible sound information received from the server apparatus 100 and outputs the information from the speaker (step S205).

Hereinafter, a series of operations of the server apparatus 100 and the terminal 200 will be described with reference to each drawing.

First, the user U1 carries the terminal 200 and starts an action. At this time, the application of the sound message system 1 of the terminal 200 is started. Then, in a case where the user U1 moves and enters the communication area 52 of the beacon transmitter 50 of FIG. 1, the location information acquisition unit 202 receives the beacon transmitted from the beacon transmitter 50. Then, the location information acquisition unit 102 acquires the location information included in the received beacon (step S201 in FIG. 9), and the location information transmission unit 204 transmits the location information to the terminal 200 (step S203 in FIG. 9).

Then, the location information acquisition unit 102 of the server apparatus 100 receives the location information from the terminal 200 (step S101 in FIG. 8). The selection unit 104 refers to the location information storage unit 114 of FIG. 2D and determines the facility, the category of the facility, and the experience content as the attribute of the location from the location information, and further refers to the jingle storage unit 110 of FIG. 5 and selects the jingle 302 corresponding to the attribute of the facility (step S103 in FIG. 8).

Further, the decision unit 106 decides the message 312 and the target name 314 corresponding to the location information or the attribute of the determined location (step S105 in FIG. 8). Then, the sound reproduction control unit 108 generates sound data 300 in the order of jingle 302, message 312, and target name 314 (step S107 in FIG. 8), and transmits the generated sound data 300 to the terminal 200 (step S109 in FIG. 8).

At the terminal 200, the reproducible sound information reception unit 206 receives the sound data 300 transmitted from the server apparatus 100 (step S203 in FIG. 9). Then, the sound reproduction output unit 208 reproduces the received sound data 300 and outputs the data from the speaker (step S205 in FIG. 9).

As described above, in the present example embodiment, the server apparatus 100 acquires the location information of a person, selects the jingle 302 based on the acquired location information, decides the reproducible sound information 310 corresponding to the location information, decides the reproducible sound information 310, generates the sound data 300 in the order of the jingle 302 and the reproducible sound information 310, and reproduces and outputs the sound data 300 on and from the terminal 200. In a case where the terminal 200 outputs the sound data 300 based on the location information, the jingle 302 is first output so that the user is able to first notice the jingle 302 and recall the experience. By selecting an appropriate jingle 302, it is possible to prevent the user from feeling uncomfortable or stressed. Then, by outputting the reproducible sound information 310 subsequent to the jingle 302, it is possible to motivate the user or induce the user to take an action.

Further, as described above, the reproducible sound information 310 has a configuration in which the message 312 and the target name 314 are reproduced in this order. The message 312 includes information for recalling the content that can be experienced at that place, and does not include the content allowing comparison with others. Therefore, the recipient of the message 312 is able to easily accept the message and make a decision to take an immediate action.

In a case where the reproducible sound information 310 is output in the order of the target name 314 and the message 312, even though the user listens to the message 312 and takes interest therein, if the target name 314 is missed, the action to go there cannot be taken. However, as in the present example embodiment, in a case where the target name 314 is finally output in the order of the message 312 and the target name 314, the user is interested in the contents of the message 312, and then can carefully listen to the target name 314 and take an action.

### Second Embodiment

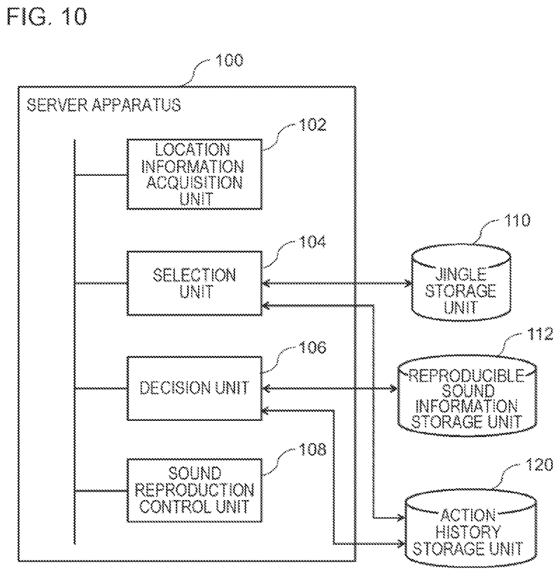

FIG. 10 is a functional block diagram that logically shows the configuration of the server apparatus 100 of the present example embodiment.

The server apparatus 100 is the same as the above example embodiment of FIG. 4, except that the jingle is selected by using the reproduction combined with the action history or the contents of the reproducible sound information is selected.

The server apparatus 100 is connected to the action history storage unit 120. The action history storage unit 120 may be an internal storage apparatus of the server apparatus 100, an external storage apparatus, or a combination thereof.

The action history including the attribute that caused the action is stored in the action history storage unit 120, and the contents of the reproducible sound information is selected by using the attribute included in the action history.

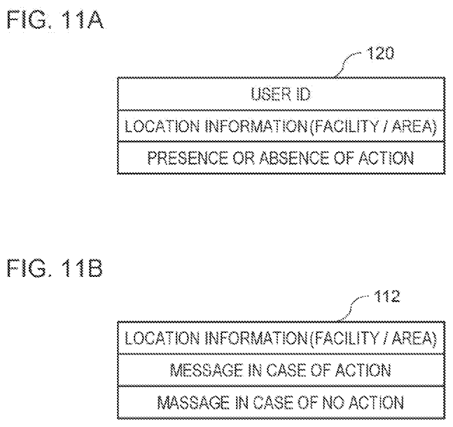

As shown in FIG. 11A, after the action history storage unit 120 stores location information or information about the facility or area and information indicating whether or not an action has been taken after the sound data 300 is output, in association with the user identification information (user ID: Identifier).

The user identification information is information that can be used to identifies the terminal 200 (for example, IP address, e-mail address, telephone number, terminal identification number, and the like), or identification information such as a user ID issued at the time of registration for use of the sound message system 1. Further, the information indicating whether or not an action has been taken is a flag. For example, in a case where an action is taken, the flag is set to 1, and in a case where no action is taken, the flag is set to 0.

In another configuration, the action history storage unit 120 may store information about the facility or area, in which the user has taken an action, or location information in association with the user ID. On the contrary, the information about the facility or area, in which the user did not take an action, or the location information may be stored in association with the user ID.

Further, as shown in FIG. 11B, the reproducible sound information storage unit 112 stores a message 312 in a case where there is an action and a message 312 in a case where there is no action in association with the location information or the information about the facility or area.

In a case where the location information is acquired, the decision unit 106 refers to the action history storage unit 120 of FIG. 11A, and acquires information indicating the presence or absence of an action corresponding to the location information. Further, the decision unit 106 refers to the reproducible sound information storage unit 112 of FIG. 11B, and acquires a message 312 corresponding to the presence or absence of an action related to the location information.

Further, the action history storage unit 120 may further include the date and time in a case where the sound data 300 is output to the user. For example, it may be decided from the action history storage unit 120 whether or not the user has visited the location information last time, and the message 312 may be changed depending on whether or not the user has visited the location information. Alternatively, it may be decided from the action history storage unit 120 whether or not the user has visited within the predetermined period, and the message 312 may be changed depending on whether or not the user has visited within the predetermined period. The method of changing the message 312 may be a method of selecting from among a plurality of messages 312 or a method of switching whether to output the message 312 or not.

The selection unit 104 or the decision unit 106 selects the jingle 302 or the message 312 by using the information of the action history, and the timing thereof may be various. For example, there may be cases where the immediately preceding history information is used, cases where the previous history information is used, and cases where the history information for a specific period is used.

In a case where the user has visited the same facility before, the following patterns may be considered: a pattern with a message 312 that prompts the user to visit the facility again; a pattern with a message 312 that recommends other experiences possible at that facility; a pattern that prompts the user to visit another facility having the same genre (category) as that facility; a pattern that prompts the user to visit another facility having a genre different from that facility; and the like.

Which pattern to use may be decided in advance for each user, each facility, or the like, or switching conditions may be set in advance. Alternatively, AI technology may be used for machine learning to decide a pattern suitable for the user.

Further, the presence or absence of an action may be detected within a predetermined time (for example, within 5 minutes) after the output of the sound message. That is, only a case where it is considered that an action was taken by the sound message is stored. Alternatively, in a case where the action is taken, the time interval from the output time of the sound message to the time when the action is taken may be stored.

According to the present example embodiment, the same effect as that of the above-described example embodiment can be obtained, and a jingle or a sound message can be selected by using the information of the action history including the attribute that caused the action. Therefore, appropriate sound messages can be delivered depending on the presence or absence of an action by the user, and the user can be effectively motivated to induce an action.

Modification of the second example embodiment will be described below.

<Form Using Other Action History>

In the above example embodiment, location information and information about the presence or absence of an action are used as the action history. In this modification, information such as the user's moving velocity, moving direction, and face orientation is used as the action history.

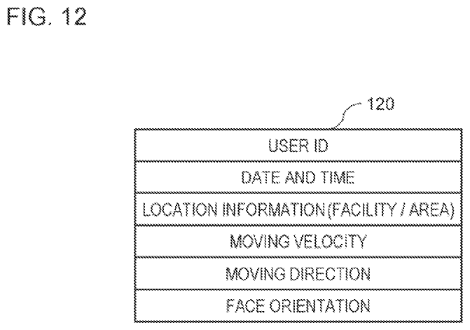

As shown in FIG. 12, the action history storage unit 120 stores at least one of information pieces such as moving velocity, moving direction, and face orientation, together with the time information (date and time) and the location information, for each user.

The location information or the information about the facility or area is the information acquired by the location information acquisition unit 102 by any of the above methods, and is stored in association with the information about the date and time at which the location information was acquired.

As for the moving velocity and the moving direction, the server apparatus 100 may receive the values measured by the acceleration sensor or the motion sensor included in the terminal 200, or may receive the values computed by the server apparatus 100 from the history information of the location information and the time information. As for the face orientation information, the server apparatus 100 may receive values measured by the motion sensor included in the terminal 200.

The selection unit 104 or the decision unit 106 selects the jingle 302 or the message 312 by using this information. As described above, as the timing of selection, the following cases are considered: the case of using the immediately preceding history information, the case of using the history information from a predetermined time before to the present, the case of using the previous history information, and the case of using the history information of a specific period.

For example, in a case where it is decided that the direction in which the user is facing is opposite to the facility to be guided by using the face orientation information of the immediately preceding history information, the selection unit 104 may select the jingle 302 with a high alert level. Then, the decision unit 106 decides the reproducible sound information 310 as follows: “If the user goes in the direction opposite to the direction the user is heading, there is a BBB that the user can experience AAA”.

Alternatively, the facility in the direction in which the user is currently facing may be selected, and the corresponding jingle 302 and message 312 may be selected and decided.

Further, it may be decided whether the user is moving on foot or on a vehicle by using the information about the moving velocity of the history information from the predetermined time before to the current time. Then, the reproducible sound information 310 may be decided based on the decision result. For example, for a user who is moving on foot, the reproducible sound information 310 can be set as follows: “There is a dumpling that the user can eat while walking around this corner on your left. The name of the store is ABC store”. For users traveling by vehicle, the reproducible sound information 310 can be set as follows: “The rice crackers that are perfect as souvenirs are in front of the next bus stop. The name of the store is XYZ store”.

In addition, it is decided whether or not the movement on foot has continued for a certain period of time or more. Based on the judgment result, for example, the use of facilities where people are able to take a break may be prompted, the use of vehicles may be prompted, or the reproducible sound information 310, which includes information such as the direction toward the nearest station or the bus stop and the departure time guidance, may be decided.

<Form Using Purchase History>

By combining at least one of the user purchase history information and attribute information in the user action history storage unit 120 and performing machine learning, the user's hobbies, tastes, and action patterns at that location are analyzed. Then, for each place (within a predetermined area), information such as facilities recommended for users, facility categories, and experience contents is registered.

The selection unit 104 and the decision unit 106 determine the location from the location information, acquire information such as facilities recommended to the user, and set and decide the corresponding jingle 302 and the reproducible sound information 310.

Although the example embodiment of the present invention has been described above with reference to the drawings, these are examples of the present invention, and various configurations other than the above can be adopted.

In the first example embodiment, the reproducible sound information storage unit 112 stores the message 312 in association with the location information, and the decision unit 106 decides the message 312 based on the location information. Further, in the second example embodiment, the message 312 is decided further based on the action history. In other example embodiment, the message 312 may be decided based on other conditions in addition to the location information.

For example, the personal attributes of the user may be conditions. The attributes of the user include gender and age group. Further, at the time of user registration, information such as hobbies, tastes, and interests may be registered in advance by the user and stored as an attribute of the user. In addition, in a case of renting out the dedicated terminal 200, the user is made to register the information about the unit of use such as an organization, a group, or a person, or the information about the type such as family, friend, lover, and the like in the case of a group. The information may be stored as an attribute of the user.

In addition, information such as heart rate, energy consumption, and body temperature measured with the wearable terminal may be included as an attribute of the user. Alternatively, an infrared sensor provided at a predetermined location may be used to measure the surface temperature of the user, decide the tension state and the like of the person, and use the tension state and the like as an attribute of the user.

In addition, information such as season, month, date, day of the week, specific period (sale holding period of a specific store, and the like), or weather (temperature, atmospheric pressure, and the like) may be a condition.

In the above example embodiment, the beacon received by the terminal 200 does not include the facility information. In another example embodiment, the beacon transmitter 50 may transmit information about facilities around the beacon transmitter 50 to the terminal 200 in response to a response from the terminal 200 that has received the beacon. The location information transmission unit 204 of the terminal 200 may transmit the received information about facilities to the server apparatus 100.

Alternatively, the terminal 200 may include a location information storage unit 114. After the location information acquisition unit 202 of the terminal 200 acquires the location information, the location information transmission unit 204 may refer to the location information storage unit 114, acquire the information about the facility or area corresponding to the acquired location information, and transmit the information to the server apparatus 100.

In the present invention, sound output is used as the main user interface, but may be combined with other user interfaces using a display unit and an operation unit. After the sound data 300 is output, the contents of the sound message itself or information about the contents may be displayed on the display of the terminal 200. The displayed contents include, for example, a uniform resource locator (URL) address of the website of the facility, contact information, a map of the location, route information, and the like. Further, the output sound data 300 may be displayed in a list and can be reproduced again by selecting the sound data 300. In this case, the jingle 302 may be configured not to be reproduced and output.

### EXAMPLES

### Example 1

In Example 1, an application that provides the service of the sound message system 1 is installed and used on the user's smartphone.

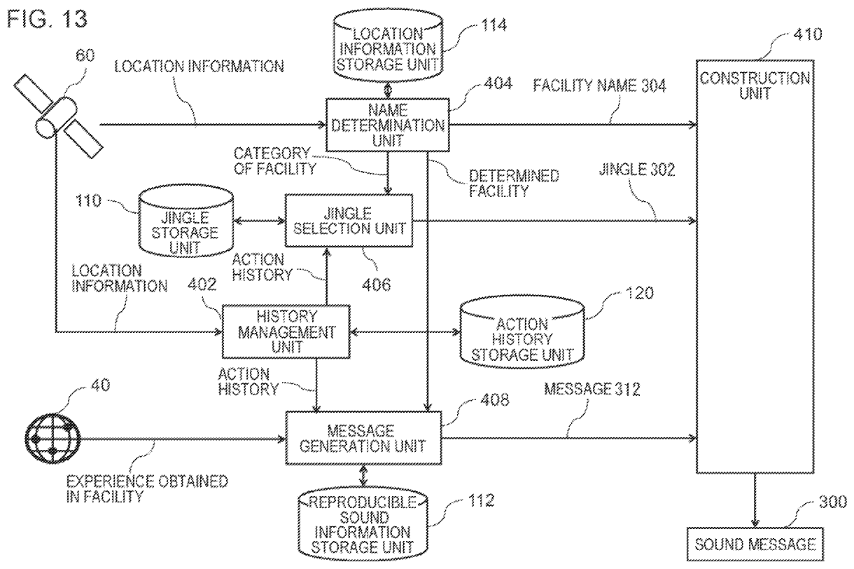

FIG. 13 is a functional block diagram showing a logical configuration of Example 1.

The server apparatus 100 includes a history management unit 402, a name determination unit 404, a jingle selection unit 406, a message generation unit 408, and a message construction unit 410.

The history management unit 402 acquires the location information of a person or the location information of the terminal 200, for example, the information received by the terminal 200 from the GPS satellite 60, and accumulates the information in the action history storage unit 120.

The name determination unit 404 determines the facility name of the facility and the category of the facility from the acquired location information with reference to the location information storage unit 114. The determined facility name 304 is transferred to the jingle selection unit 406 and the message construction unit 410, and the information about the determined facility is transferred to the message generation unit 408.

The jingle selection unit 406 selects a jingle, using the facility categories received from the name determination unit 404 and the action history information received from the history management unit 402. Then, the jingle selection unit 406 transfers the selected jingle 302 to the message construction unit 410.

The message generation unit 408 searches the Internet or the like, collects and accumulates information about the experience obtained at each facility, and stores the reproducible sound information 310 in the reproducible sound information storage unit 112. Further, the message generation unit 408 generates the message 312, which includes the experience contents of the facility selected from the reproducible sound information storage unit 112 in accordance with the information about the facility determined by the name determination unit 404 or the action history information received from the history management unit 402, and transfers the message to the message construction unit 410.

The message construction unit 410 generates and outputs sound data 300 for reproducing the jingle 302, the message 312, and the target name 314 received from the jingle selection unit 406, the message generation unit 408, and the name determination unit 404 in this order. The sound data 300 is transmitted to the terminal 200 so as to be reproduced and output.

### Example 2

In Example 2, the sound message system 1 is used at the construction site.

The terminal 200 is carried by each worker. The beacon transmitter 50 is installed in a dangerous place or the like.

In a case where a worker approaches a dangerous place, the location information acquisition unit 202 of the terminal 200 receives the beacon signal transmitted from the beacon transmitter 50, and the location information transmission unit 204 transmits the location information, which is included in the beacon signal, to the server apparatus 100.

A plurality of jingles are stored in the jingle storage unit 110 in accordance with the alert level of the dangerous place. Further, the jingle storage unit 110 stores the location information of each dangerous place in the construction site and the alert level of the dangerous place in association with each other. The selection unit 104 determines the alert level of the dangerous place from the received location information, and selects the jingle corresponding to the determined alert level. It can be considered that, the higher the alert level, the more urgent the jingle.

Further, the action history storage unit 120 stores sound information of a plurality of messages in accordance with the attributes of the dangerous place. Further, the action history storage unit 120 stores the location information and the attributes of the dangerous place in association with each other. The attributes of the dangerous place include, for example, overhead caution, foot caution, weight restriction, fire prohibition, and the like. Alternatively, the attributes may include attributes of the work content, which include caution for aerial work, prohibition of single work, ventilation required, and the like. Then, the decision unit 106 determines the attribute of the dangerous place from the location information and selects the message corresponding to the determined attribute. Alternatively, the selection unit 104 may select the jingle in accordance with the above-mentioned attribute of the dangerous place. For example, different jingles may be used to indicate whether the location to watch out for is overhead or underfoot.

### Example 3

In Example 3, the sound message system 1 is used as a tourist guide for foreign tourists.

For example, the terminal 200 is rented to foreign tourists at airports, tourist spots, and the like. Alternatively, a QR code (registered trademark) for downloading the application to the smartphone owned by the user may be transferred, the user may be registered, and the service may be provided.

The selection of the language (Japanese, English, Chinese, Korean, French, and the like) of the message 312 may be accepted in the setting menu and output in the selected language.

### Example 4

In Example 4, by outputting the store information as a sound message, the user is prompted to use the store by a method different from the conventional advertisement or promotion.

Nowadays, advertisers are eager to deliver more personalized and effective information to personal terminals such as personal computers, smartphones, and tablets.

On the other hand, since a person who receives the information finds it troublesome to take out the terminal, even if the information is the information the person wants, the person does not take out the terminal and miss the information. Thus, from the viewpoint of advertisers, there was a problem that the person could not reach the information.

Therefore, as means for overcoming the problem of taking out the terminal, the sound message of the present invention using sound as a user interface (UI) is used.

Note that, the general sound message mainly consists of information for explaining the target, and has a problem that the general sound message has not reached the point of motivation or action induction. In addition, sound messages that are reproduced interrupting person movements and conversations cause discomfort and cause stress.

By adopting the sound message system 1 of the present invention, these problems can be solved.

First, the location information of the store or facility of which the advertisement is to be delivered is registered in the location information storage unit 114. For example, the sound message system 1 is used in a place where a plurality of stores is present in a certain area such as an outlet mall. The location information of each store and each equipment (nursing equipment, diaper changing bed, bench, smoking area, toilet, elevator, emergency exit, and the like) can be registered.

The jingle storage unit 110 stores jingle 302 that evokes awareness and experience without stressing the user for each store or equipment, or for each category thereof. Then, the reproducible sound information storage unit 112 stores a message 312 including contents that can be experienced or executed at the store or equipment.

Each store registers a message 312 for attracting users. For example, the following messages are registered for each store:

“You can eat the sweet and cold Hokkaido Yubari melon soft serve ice cream”, and “We will hold a 30-minute time sale from 15:00. We have a rich lineup of fashion trends this fall. Please do not miss it”.

As in the latter message, the delivery time may be determined. The messages may be registered together with the delivery target time (for example, 14:00 to 15:00) so that the messages are selected only at the specified time.

For example, the user is able to download and start the application and start using the sound message system 1. The application may be dedicated to a certain outlet mall, or may be commonly used in a plurality of commercial facilities, and various forms are conceivable.

In addition, a setting screen may be provided in which the equipment information that the user wants to obtain can be specified in advance. Alternatively, information such as whether the user is a smoker, has an infant, or is an elderly person may be registered in advance as an attribute of the user. A message using the location information of the smoking area may be delivered to smokers, a message using the location information of the nursing room may be delivered to users with babies, and a message using the location information of elevators, escalators, benches, or the like may be delivered to the elderly.

In addition, the message corresponding to the above-mentioned location information related to smoking, breastfeeding, rest, and the like may be overloaded if the message is delivered each time the location is approached. Therefore, it is preferable to store the time when these messages are delivered so that the message corresponding to the same location information is not delivered for a certain period from the time when the previous message was delivered.

In addition, the action cycle of the user may be estimated using the information of the action history, and the message may be delivered at the cycle suitable for the user.

Although the present invention has been described above with reference to the example embodiment and examples, the present invention is not limited to the above example embodiment and examples. Various changes that can be understood by those skilled in the art can be made within the scope of the present invention in terms of the structure and details of the present invention.

In addition, in a case where information about a user is acquired and used in this invention, it is assumed that the acquisition and using shall be done legally.

Hereinafter, an example of the reference form will be added.

1. A server apparatus includes

a location information acquisition unit that acquires location information of a terminal or location information of a person,

a selection unit that selects a jingle by using the acquired location information,

a decision unit that decides reproducible sound information by using the acquired location information, and

a sound reproduction control unit that generates sound information so as to reproduce the jingle and the reproducible sound information in this order, and causes the terminal to reproduce the generated sound information.

2. In the server apparatus described in 1,

the reproducible sound information includes information about contents that a person is able to experience in relation to the location information and information for determining a facility indicated by the location information, in this order.

3. In the server apparatus described in 1 or 2,

the selection unit determines an attribute of a location of the location information acquired by the location information acquisition unit, and selects further the jingle based on the determined attribute.

4. In the server apparatus described in 3,

the selection unit determines a facility by using the location information and sets a category of the facility as the attribute of the location.

5. In the server apparatus described in 3 or 4,

the selection unit sets an attribute of contents that can be experienced at the location indicated by the location information as the attribute of the location.

6. In the server apparatus described in any one of 1 to 5,

an action history including an attribute that causes an action is stored in a storage apparatus, and the decision unit selects contents of the reproducible sound information by using the attribute included in the action history.

7. In a data structure of a sound message that is generated to be reproduced on a terminal,

the sound message includes

a jingle selected by using location information of the terminal or location information of a person, and

reproducible sound information decided by using the location information, the ingle and the reproducible sound information being reproduced in this order, and

the reproducible sound information further includes

information about the content that a person is able to experience in relation to the location information, and

information for determining the facility indicated by the location information, the information about the contents and the information for determining the facility being reproduced in this order.

8. In the data structure described in 7,

the reproducible sound information includes information about contents that a person is able to experience in relation to the location information and information for determining a facility indicated by the location information, in this order.

9. An information processing method executed by a server apparatus includes

acquiring location information of a terminal or location information of a person,

selecting a jingle by using the acquired location information,

deciding reproducible sound information by using the acquired location information, and

generating sound information so as to reproduce the jingle and the reproducible sound information in this order, and causing the terminal to reproduce the generated sound information.

10. In the information processing method described in 9,

the reproducible sound information includes information about contents that a person is able to experience in relation to the location information and information for determining a facility indicated by the location information, in this order.

11. In the information processing method described in 9 or 10, wherein the method executed by the server apparatus comprises determining an attribute of a location of the acquired location information, and selecting further the jingle based on the determined attribute.

12. In the information processing method described in 11, wherein the method executed by the server apparatus comprises determines a facility by using the location information and setting a category of the facility as the attribute of the location.

13. In the information processing method described in 11 or 12, wherein the method executed by the server apparatus comprises setting an attribute of contents that can be experienced at the location indicated by the location information as the attribute of the location.

14. In the information processing method described in any one of 9 to 13,

an action history including the attribute that caused the action is stored in the storage apparatus, and the method executed by the server apparatus comprises selecting the contents of the reproducible sound information by using the attribute included in the action history.

15. A program causing the computer to execute

a procedure of acquiring location information of a terminal or location information of a person,

a procedure of selecting a jingle by using the acquired location information,

a procedure of deciding reproducible sound information by using the acquired location information, and

a procedure of sound reproduction control unit that generates sound information so as to reproduce the jingle and the reproducible sound information in this order, to cause the terminal to reproduce the generated sound information.

16. In the program described in 15,

the reproducible sound information includes information about contents that a person is able to experience in relation to the location information and information for determining a facility indicated by the location information, in this order.

17. In the program described in 15 or 16,

the program causes the computer to execute a procedure of determining an attribute of a location of the acquired location information to select further the jingle based on the determined attribute.

18. In the program described in 17,

the program causes the computer to execute a procedure of determining a facility by using the location information and setting a category of the facility as the attribute of the location.

19. In the program described in 17 or 18,

the program causes the computer to execute a procedure of setting an attribute of contents that can be d at the location indicated by the location information as the attribute of the location.

20. In the program described in any one of 15 to 19,

the program causes the computer to execute a procedure of storing an action history including an attribute that causes an action in a storage apparatus, to select contents of the reproducible sound information by using the attribute included in the action history.

21. A sound message system includes

a server apparatus, and

a terminal.

The server apparatus includes

a location information acquisition unit that acquires location information of a terminal or location information of a person,

a selection unit that selects a jingle by using the acquired location information,

a decision unit that decides reproducible sound information by using the acquired location information, and

a transmission unit that generates sound information so as to reproduce the jingle and the reproducible sound information in this order, and transmitting the generated sound information to the terminal.

The terminal includes

a unit that transmits the location information to the server apparatus,

a unit that receives the sound information from the server apparatus, and

an output unit that outputs the sound information when the sound information is received.

22. In the sound message system described in 21,

the reproducible sound information includes information about contents that a person is able to experience in relation to the location information and information for determining a facility indicated by the location information, in this order.

23. In the sound message system described in 21 or 22,

the selection unit determines an attribute of a location of the location information acquired by the location information acquisition unit, and selects further the jingle based on the determined attribute.

24. In the sound message system described in 23,

the selection unit determines a facility by using the location information and sets a category of the facility as the attribute of the location.

25. In the sound message system described in 23 or 24,

the selection unit sets an attribute of contents that can be experienced at the location indicated by the location information as the attribute of the location.

26. In the sound message system described in any one of 21 to 25,

an action history including an attribute that causes an action is stored in a storage apparatus, and the decision unit selects contents of the reproducible sound information by using the attribute included in the action history.

This application claims priority on the basis of Japanese Patent Application No. 2018-185716 filed on Sep. 28, 2018, and incorporates all of its disclosures herein.

What is claimed is:

1. A server apparatus comprising:
a location information acquisition unit that acquires location information of a terminal or location information of a person;
a selection unit that selects a jingle by using the acquired location information;
a decision unit that decides reproducible sound information by using the acquired location information; and
a sound reproduction control unit that generates sound information so as to reproduce the jingle and the reproducible sound information in this order, and causes the terminal to reproduce the generated sound information.

2. The server apparatus according to claim 1, wherein the reproducible sound information includes information about contents that a person is able to experience in relation to the location information and information for determining a facility indicated by the location information, in this order.

3. The server apparatus according to claim 1, wherein the selection unit determines an attribute of a location of the location information acquired by the location information acquisition unit, and selects further the jingle based on the determined attribute.

4. The server apparatus according to claim 3, wherein the selection unit determines a facility by using the location information and sets a category of the facility as the attribute of the location.

5. The server apparatus according to claim 3, wherein the selection unit sets an attribute of contents that can be experienced at the location indicated by the location information as the attribute of the location.

6. The server apparatus according to claim 1, wherein an action history including an attribute that causes an action is stored in a storage apparatus, and the decision unit selects contents of the reproducible sound information by using the attribute included in the action history.

7-8. (canceled)

9. An information processing method executed by a server apparatus, the method comprising:
acquiring location information of a terminal or location information of a person,
selecting a jingle by using the acquired location information,
deciding reproducible sound information by using the acquired location information, and
generating sound information so as to reproduce the jingle and the reproducible sound information in this order, and causing the terminal to reproduce the generated sound information.

10. The information processing method according to claim 9, wherein the reproducible sound information includes information about contents that a person is able to experience in relation to the location information and information for determining a facility indicated by the location information, in this order.

11. The information processing method according to claim 9, wherein the method executed by the server apparatus comprises determining an attribute of a location of the acquired location information, and selecting further the jingle based on the determined attribute.

12. The information processing method according to claim 11, wherein the method executed by the server apparatus comprises determining a facility by using the location information and setting a category of the facility as the attribute of the location.

13. The information processing method according to claim 11, wherein the method executed by the server apparatus comprises setting an attribute of contents that can be experienced at the location indicated by the location information as the attribute of the location.

14. The information processing method according to claim 9, wherein an action history including an attribute that causes an action is stored in a storage apparatus, and the method executed by the server apparatus comprises selecting contents of the reproducible sound information by using the attribute included in the action history.

15. A non-transitory computer-readable storage medium storing a program causing a computer to executes:
a procedure of acquiring location information of a terminal or location information of a person,
a procedure of selecting a jingle by using the acquired location information,
a procedure of deciding reproducible sound information by using the acquired location information, and
a procedure of generating sound information so as to reproduce the jingle and the reproducible sound information in this order, to cause the terminal to reproduce the generated sound information.

16. The non-transitory computer-readable storage medium according to claim 15, wherein the reproducible sound information includes information about contents that a person is able to experience in relation to the location information and information for determining a facility indicated by the location information, in this order.

17. The non-transitory computer-readable storage medium according to claim 15, wherein the program causes the computer to execute a procedure of determining an attribute of a location of the location information acquired by the location information acquisition unit to select further the jingle based on the determined attribute.

18. The non-transitory computer-readable storage medium according to claim 17, wherein the program causes the computer to execute a procedure of determining a facility by using the location information and setting a category of the facility as the attribute of the location.

19. The non-transitory computer-readable storage medium according to claim 17, wherein the program causes the computer to execute a procedure of setting an attribute of contents that can be experienced at the location indicated by the location information as the attribute of the location.

20. The non-transitory computer-readable storage medium according to any one of claim 15, wherein the program causes the computer to execute a procedure of storing an action history including an attribute that causes an action in a storage apparatus, to select contents of the reproducible sound information by using the attribute included in the action history.

21-26. (canceled)
